(19) United States
(12) Patent Application Publication
(10) Pub. No.: US 2019/0143966 A1
(43) Pub. Date: May 16, 2019

(54) VEHICLE CONTROL APPARATUS

(71) Applicant: DENSO CORPORATION, Kariya-city, Aichi-pref. (JP)

(72) Inventors: Yasuhiko MUKAI, Kariya-city, Aichi-pref. (JP); Tetsuya TOKUDA, Kariya-city, Aichi-pref. (JP); Masanobu YAMAGUCHI, Kariya-city, Aichi-pref. (JP); Noriyasu NOTO, Kariya-city, Aichi-pref. (JP)

(21) Appl. No.: 16/092,344

(22) PCT Filed: Apr. 7, 2017
(86) PCT No.: PCT/JP2017/014527

§ 371 Date: Oct. 9, 2018

(30) Foreign Application Priority Data
Apr. 11, 2016 (JP) 2016-079121

(51) Int. Cl. B60W 30/09; B60W 30/095; B60W 40/068; B60W 10/20; B60W 10/18

(52) U.S. Cl. CPC B60W 30/09; B60W 30/0953; B60W 30/0956; B60W 40/068; B60W 2550/148; B60W 10/18; B60W 2550/10; B60W 2550/12; B60W 10/20

(57) ABSTRACT

A vehicle control apparatus includes a collision determining section configured to determine a probability of a collision between an own vehicle and an object located ahead of the own vehicle, a control section configured to, in a case where it is determined by the collision determining section that there is a probability of a collision, execute automatic steering control of steering the own vehicle as collision avoidance control for avoiding a collision between the own vehicle and the object, and a road surface determining section configured to perform processing of determining whether or not a road surface on which the own vehicle is traveling is a low-μ road. The control section prohibits execution of the automatic steering control in a case where it is determined by the road surface determining section that the road surface is a low-μ road.

### CROSS-REFERENCE TO RELATED APPLICATIONS

This application is based on and claims the benefit of priority from earlier Japanese Patent Application No. 2016-079121 filed on Apr. 11, 2016, the description of which is incorporated herein by reference.

### TECHNICAL FIELD

The present disclosure relates to a vehicle control apparatus which executes collision avoidance control for avoiding a collision between an own vehicle and an object in the case where there is a probability of the collision between the own vehicle and the object.

### BACKGROUND ART

As this type of control apparatus, a control apparatus is known which executes automatic braking control of providing braking force to an own vehicle to avoid a collision between the own vehicle which is traveling and an object located ahead of the own vehicle. Further, as seen in the following PTL 1, a control apparatus is known which changes a collision avoidance method in the case where a condition of a road surface on which the own vehicle is traveling changes during execution of automatic braking control. Specifically, this control apparatus first determines whether or not a collision between the own vehicle and an object present ahead of the own vehicle can be avoided only by automatic braking control during execution of the automatic braking control. In the case where it is determined that a collision cannot be avoided, the control apparatus releases the automatic braking control and executes automatic steering control of steering the own vehicle to avoid a collision. By this means, a collision between the own vehicle and the object is avoided.

### CITATION LIST

### Patent Literature

[PTL 1] JP H5-58319 A

### SUMMARY OF THE INVENTION

While, in the control apparatus disclosed in the above-described PTL 1, automatic steering control for avoiding a collision with an object is executed, if the automatic steering control is executed in a situation where a friction coefficient of a traveling road surface is low, there is a risk that the own vehicle may exhibit unstable behavior.

The present disclosure is mainly directed to providing a vehicle control apparatus which can prevent an own vehicle from exhibiting unstable behavior when collision avoidance control for avoiding a collision between the own vehicle and an object located ahead of the own vehicle is executed.

Means for solving the above problem and effects thereof will be described below.

The present disclosure includes a collision determining section configured to determine a probability of a collision between an own vehicle and an object located ahead of the own vehicle, a control section configured to, in a case where it is determined by the collision determining section that there is a probability of a collision, execute automatic steering control of steering the own vehicle as collision avoidance control for avoiding a collision between the own vehicle and the object, and a road surface determining section configured to perform processing of determining whether or not a road surface on which the own vehicle is traveling is a low-μ road, the control section prohibiting execution of the automatic steering control in a case where it is determined by the road surface determining section that the road surface is a low-μ road.

In the above disclosure, in the case where it is determined by the collision determining section that there is a probability of a collision between the own vehicle and the object located ahead of the own vehicle, automatic steering control is executed by the control section as collision avoidance control for avoiding a collision between the own vehicle and the object.

In this configuration, in the above disclosure, it is determined by the road surface determining section whether or not the road surface on which the own vehicle is traveling is a low-μ road. In the case where it is determined by the road surface determining section that the road surface is a low-μ road, execution of automatic steering control is prohibited by the control section. It is therefore possible to prevent the vehicle from exhibiting unstable behavior due to execution of the automatic steering control when the collision avoidance control is executed in the case where there is a probability of a collision between the own vehicle and the object located ahead of the own vehicle.

### BRIEF DESCRIPTION OF DRAWINGS

The above and other objects, features and advantages of the present disclosure will become clearer from the following detailed description with reference to the accompanying drawings, in which:

FIG. 1 is an overall configuration diagram of an in-vehicle system according to a first embodiment;

FIG. 2 is a flowchart illustrating procedure of collision avoidance control processing;

FIG. 3 is a diagram for describing a method of determining a probability of a collision between an own vehicle and a forward object;

FIG. 4 is a flowchart illustrating a procedure of collision avoidance control processing according to a second embodiment;

FIG. 5 is a flowchart illustrating a procedure of collision avoidance control processing according to a third embodiment;

FIG. 6 is a diagram illustrating a method of calculating a lateral direction avoidance amount of the own vehicle;

FIG. 7 is a diagram illustrating an example of a free space width;

FIG. 8 is a diagram illustrating a maximum avoidance amount of the own vehicle;

FIG. 9 is a diagram illustrating a relationship among own vehicle speed, an outside air temperature, and the maximum avoidance amount;

FIG. 10 is a flowchart illustrating a procedure of collision avoidance control processing according to a fourth embodiment; and

FIG. 11 is a time chart illustrating collision avoidance control.

### DESCRIPTION OF EMBODIMENTS

### First Embodiment

A first embodiment which is an embodiment of a vehicle control apparatus according to the present disclosure will be described below with reference to the drawings. The control apparatus according to the present embodiment functions as a pre-crash safety system which detects an object located around an own vehicle and executes collision avoidance control to avoid a collision between the own vehicle and an object such as an automobile located ahead of the own vehicle or to reduce damage from the collision.

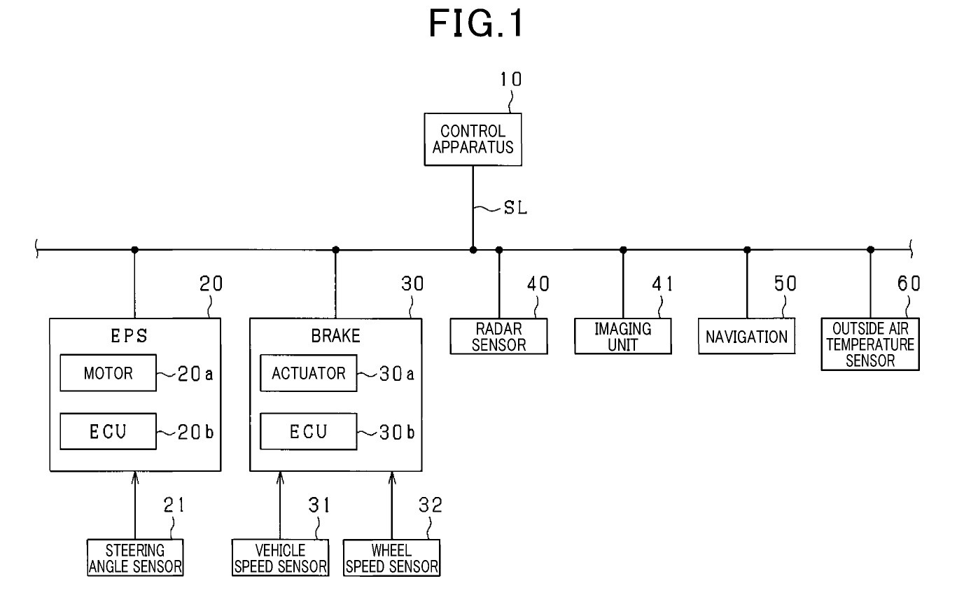

As illustrated in FIG. 1, the control apparatus 10 is a computer including a CPU, a ROM, a RAM, an I/O, or the like, and performs various kinds of control by the CPU executing a program installed in the ROM. The control apparatus 10 transmits/receives data to/from each unit connected to a communication line SL in accordance with a communication protocol such as CAN set in advance.

The vehicle includes an electric power steering unit 20, a braking unit 30, a steering angle sensor 21 which detects a steering angle of a steered wheel of the vehicle, a vehicle speed sensor 31 which detects a traveling speed of the own vehicle, a wheel speed sensor 32 which detects a rotation speed of a wheel of the own vehicle, and an outside air temperature sensor 60 which detects an outside air temperature around the own vehicle.

The electric power steering unit 20 includes a steering motor 20a which applies steering force to a steering wheel, and a steering ECU 20b. The steering ECU 20b executes power steering control so as to generate assist force upon change of a steering angle of the steered wheel by the steering motor 20a, on the basis of the steering angle detected by the steering angle sensor 21 when a driver performs steering operation.

Further, the steering ECU 20b performs automatic steering control in which the steering angle is automatically controlled by the steering motor 20a without steering operation by the driver, as collision avoidance control, on the basis of a steering control signal transmitted from the control apparatus 10 via the communication line SL.

The braking unit 30 includes a brake actuator 30a which adjusts a hydraulic pressure of a master cylinder and a brake ECU 30b. The brake ECU 30b performs ABS control, traction control, or the like by the brake actuator 30a on the basis of the hydraulic pressure of the master cylinder, own vehicle speed which is traveling speed of the own vehicle detected by the vehicle speed sensor 31, and the rotation speed of the wheel detected by the wheel speed sensor 32. The ABS control is braking control performed to maintain an appropriate slip ratio which is slippage in the rotation direction of each wheel. The slip ratio may only be calculated, for example, on the basis of the own vehicle speed detected by the vehicle speed sensor 31 and the rotation speed of the wheel detected by the wheel speed sensor 32.

Further, the brake ECU 30b performs automatic braking control of automatically applying braking force to the wheels by the brake actuator 30a without braking operation by the driver, as the collision avoidance control, on the basis of a braking control signal transmitted from the control apparatus 10 via the communication line SL.

The vehicle includes a radar sensor 40. The radar sensor 40, which detects an object present ahead of the own vehicle by utilizing directional electromagnetic waves such as millimeter waves and a laser, is, for example, attached at a front portion of the own vehicle so that an optical axis of the radar sensor 40 is directed ahead of the own vehicle. The radar sensor 40 acquires a distance to a forward object, a relative speed with respect to the forward object, or the like, as object information by scanning a region extending in a predetermined range ahead of the own vehicle with a radar signal for each predetermined to period and receiving electromagnetic waves reflected from a surface of the forward object. Specifically, the object information includes a distance to a forward object in a traveling direction of the own vehicle and a relative speed with respect to the forward object in the traveling direction of the own vehicle. The acquired object information is input to the control apparatus 10.

The vehicle includes an imaging unit 41. The imaging unit 41, which is an in-vehicle camera, is configured by a CCD camera, a CMOS image sensor, a near-infrared camera, or the like. The imaging unit 41 captures images of surroundings including a road on which the own vehicle is traveling. The imaging unit 41, which is attached, for example, near the upper end of a windshield of the own vehicle, captures images of a region extending in a range at a predetermined imaging angle around an imaging axis toward the front of the vehicle. Note that the imaging unit 41 may be a monocular camera or may be a stereo camera.

The imaging unit 41 generates image data indicating a captured image and sequentially outputs the image data to the control apparatus 10. The control apparatus 10 recognizes boundaries such as section lines which mark out an own vehicle lane, which are respectively located in left and right directions ahead of the own vehicle, on the basis of the input image data.

The vehicle includes a navigation unit 50. The navigation unit 50 acquires map data from a map storage medium in which road map data and various kinds of information are recorded and calculates a current location of the own vehicle on the basis of a GPS signal, or the like, received via a GPS antenna. Further, the navigation unit 50 performs control for displaying a current place of the own vehicle on a display screen, control for guiding a route from the current place to a destination, or the like.

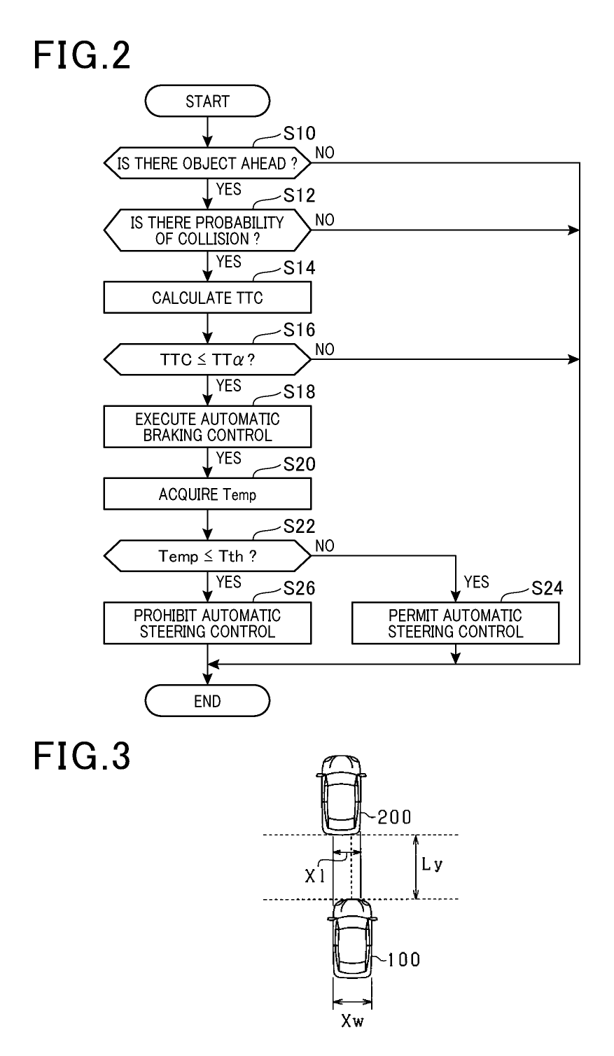

Subsequently, collision avoidance control processing according to the present embodiment will be described with reference to FIG. 2. This processing is repeatedly executed by the control apparatus 10, for example, with a predetermined processing period (for example, 50 ms).

In this series of processing, first, in step S10, it is determined whether or not there exists an object ahead of the own vehicle. Here, whether or not there exists an object ahead may only be determined on the basis of, for example, the object information acquired from the radar sensor 40.

In the case where it is determined in step S10 that there exists an object, the processing proceeds to step S12, and it is determined whether or not there is a probability of a collision between the forward object and the own vehicle. In the present embodiment, the processing in step S12 corresponds to a collision determining section. In the present embodiment, respective lateral positions at a left end portion and at a right end portion of the forward object are acquired on the basis of the object information acquired from the radar sensor 40 or the image acquired from the imaging unit 41. A lap ratio La is calculated on the basis of the acquired lateral positions, and, in the case where it is determined that the calculated lap ratio La is equal to or greater than a determination threshold, it is determined that there is a probability of a collision. In the present embodiment, as illustrated in FIG. 3, the lap ratio La is a parameter obtained by the following expression (1) where a width of the own vehicle 100 is set as Xw, and a width of a region where the width of the own vehicle 100 overlaps with a width of a forward object 200 is set as XI.

La=Xl/Xw (1)

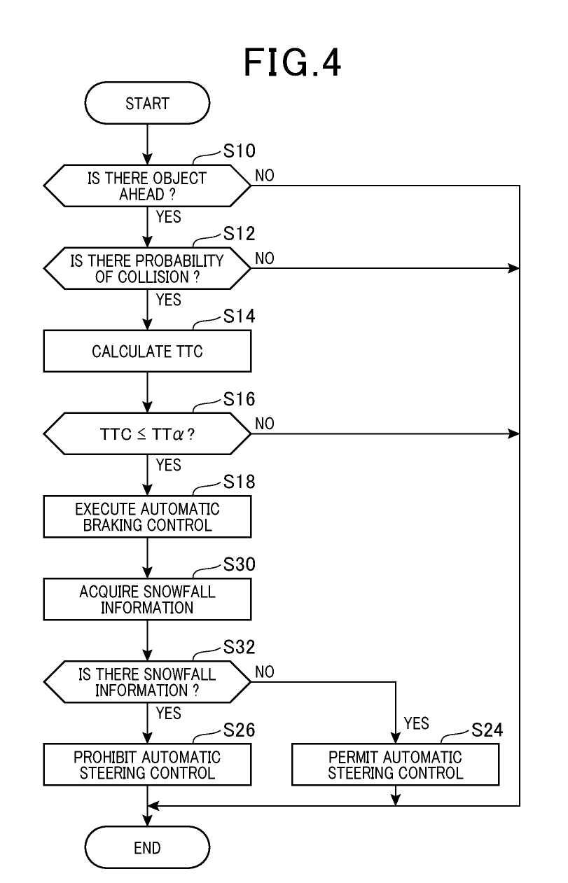

Note that a method of determining whether or not there is a probability of a collision between the forward object and the own vehicle is not limited to the above-described method, and, for example, a method disclosed in FIG. 4 in JP 2015-232825 A may be used.

In the case where it is determined in step S12 that there is a probability of a collision, the processing proceeds to step S14, and collision prediction time TTC (Time To Collision) which is time to collision between the own vehicle and the forward object is calculated. For example, as illustrated in FIG. 3, the collision prediction time TTC may only be calculated on the basis of a distance Ly to the forward object 200 in the traveling direction of the own vehicle 100 acquired from the radar sensor 40 and relative speed with respect to the forward object 200 in the traveling direction of the own vehicle 100.

In the following step S16, it is determined whether or not the calculated collision prediction time TTC is equal to or less than threshold time TTα. This processing is for determining whether or not to execute collision avoidance control. Note that the threshold time TTα may be variably set on the basis of the relative speed of the own vehicle with respect to the forward object in the traveling direction of the own vehicle.

In the case where an affirmative determination is made in step S16, the processing proceeds to step S18, and automatic braking control by the braking unit 30 is executed as collision avoidance control. In the following step S20, an outside air temperature Temp detected by the outside air temperature sensor 60 is acquired. Note that, in the present embodiment, the processing in step S20 corresponds to a temperature acquiring section.

In the following step S22, it is determined whether or not the acquired outside air temperature Temp is equal to or lower than a predetermined temperature Tth (for example, −4° C.). In the present embodiment, the predetermined temperature Tth is set to a temperature at which a road surface is assumed to freeze, and, specifically, is set to a temperature below zero (for example, −4° C.). The processing in step S22 is processing for determining whether or not a road surface on which the own vehicle is traveling is a low-μ road, and corresponds to a road surface determining section in the present embodiment.

In the case where it is determined in step S22 that the outside air temperature Temp is higher than the predetermined temperature Tth, the processing proceeds to step S24, and execution of automatic steering control by the electric power steering unit 20 is permitted.

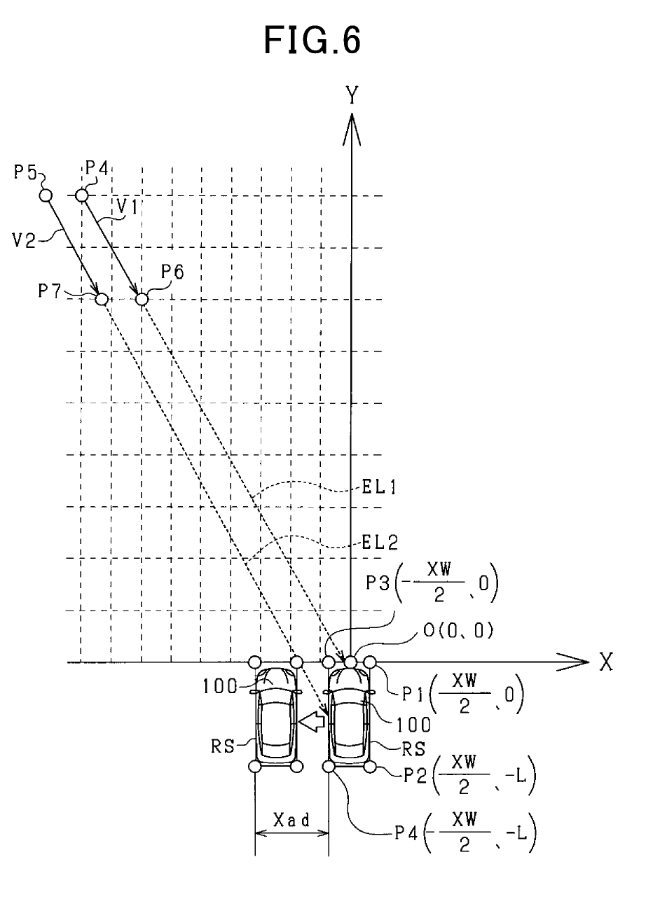

Note that whether or not to execute automatic steering control as collision avoidance control is determined on the basis of the collision prediction time TTC and an operating point determined from the relative speed of the own vehicle with respect to the forward object in the traveling direction of the own vehicle. Since this determination method is disclosed in, for example, FIG. 6 in JP 2015-232825 A, detailed description thereof will be omitted.

Meanwhile, in the case where it is determined in step S22 that the outside air temperature Temp is equal to or lower than the predetermined temperature Tth, it is determined that the road surface on which the own vehicle is traveling is a low-u, road, and the processing proceeds to step S26. In step S26, execution of automatic steering control is prohibited. By this means, unstable behavior such as slipping of the own vehicle caused by execution of the automatic steering control is prevented.

As described above, in the present embodiment, in the case where it is determined that the outside air temperature Temp is equal to or lower than the predetermined temperature Tth, execution of the automatic steering control as the collision avoidance control is prohibited. It is therefore possible to prevent the own vehicle from exhibiting unstable behavior due to execution of the automatic steering control when collision avoidance control is executed in the case where there is a probability of a collision between the own vehicle and the forward object.

### Second Embodiment

A second embodiment will be described below with reference to the drawings mainly concerning differences with the above-described first embodiment. In the present embodiment, a method of determining whether or not the road surface on which the own vehicle is traveling is a low-μ road is changed.

FIG. 4 illustrates a procedure of collision avoidance control processing according to the present embodiment. This processing is repeatedly executed by the control apparatus 10, for example, with a predetermined processing period. Note that, in FIG. 4, the same reference numerals are assigned to processing which is the same as the processing illustrated in previous FIG. 2 for convenience sake.

In this series of processing, after the processing in step S18, in step S30, processing of acquiring snowfall information in a region to which a traveling route of the own vehicle belongs is performed. Here, the snowfall information may only be acquired by the navigation unit 50 through wireless communication. Note that, in the present embodiment, the processing in step S30 corresponds to an information acquiring section.

In the following step S32, it is determined whether or not snowfall information has been acquired in step S30. In the case where it is determined in step S32 that snowfall information has not been acquired, the processing proceeds to step S24. In contrast, in the case where it is determined in step S32 that snowfall information has been acquired, it is determined that there is a probability that the own vehicle may exhibit unstable behavior due to the automatic steering control, and execution of the automatic steering control is prohibited in step S26.

As described above, also according to the present embodiment, it is possible to provide effects similar to those in the above-described first embodiment.

### Third Embodiment

A third embodiment will be described below with reference to the drawings mainly concerning differences with the above-described first embodiment. In the present embodiment, a method of prohibiting automatic steering control is changed.

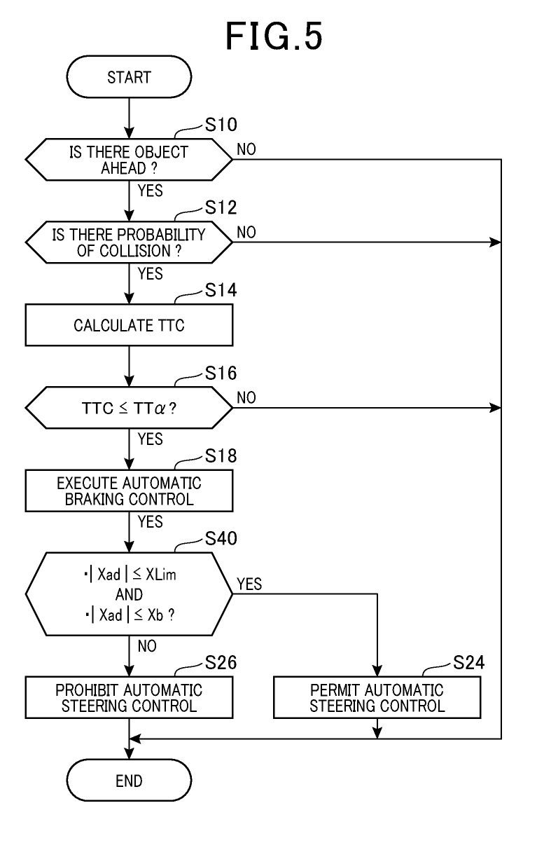

FIG. 5 illustrates a procedure of collision avoidance control processing according to the present embodiment. This processing is repeatedly executed by the control apparatus 10, for example, with a predetermined processing period. Note that, in FIG. 5, the same reference numerals are assigned to processing which is the same as the processing illustrated in previous FIG. 2 for convenience sake.

In this series of processing, after the processing in step S18, in step S40, it is determined whether or not a logical AND of a first condition that an absolute value of a lateral direction avoidance amount Xad is equal to or less than a free space width XLim and a second condition that the absolute value of the lateral direction avoidance amount Xad is equal to or less than a maximum avoidance amount Xb, is true. In the present embodiment, the processing in step S40 includes an avoidance amount calculating section and a maximum value calculating section. The processing in step S40 is processing for determining whether or not to prohibit execution of the automatic steering control.

In the first condition, the lateral direction avoidance amount Xad, which is an amount of movement in a horizontal direction which is orthogonal to the traveling direction of the own vehicle, is an amount of movement necessary for eliminating a probability of a collision between the forward object and the own vehicle. An example of a method of calculating the lateral direction avoidance amount Xad will be described below with reference to FIG. 6.

First, as illustrated in FIG. 6, a two-dimensional orthogonal coordinate system in which a coordinate axis extending in the traveling direction of the own vehicle 100 is set as a Y axis and a coordinate axis which is orthogonal to the Y axis and extends in a horizontal direction of the own vehicle is set as an X axis, is defined. The origin O (0, 0) of this coordinate system is made to match a center portion at a font end of the own vehicle 100.

When a width of the own vehicle 100 is set as Xw, and an entire length of the own vehicle 100 is set as L, a range where the own vehicle 100 exists is defined with a rectangular region including corners at a first coordinate point P1 defined with (Xw/2, 0), a second coordinate point P2 defined with (Xw/2, −L), a third coordinate point P3 defined with (−Xw/2, 0) and a fourth coordinate point P4 defined with (−Xw/2, −L). Hereinafter, this rectangular region will be referred to as an own vehicle region RS.

Relative speed vectors respectively at a right end portion and a left end portion of the forward object 200 on the own vehicle 100 side when the forward object 200 is viewed from the own vehicle 100 are calculated on the basis of the object information acquired from the radar sensor 40 in the previous processing period and the object information acquired from the radar sensor 40 in the processing period of this time. Specifically, positions at the right end portion and the left end portion of the forward object 200 on the own vehicle 100 side in the previous processing period are respectively set as a fourth coordinate point P4 and a fifth coordinate point P5, and positions at the right end portion and the left end portion of the forward object 200 on the own vehicle 100 side in the processing period of this time are respectively set as a sixth coordinate point P6 and a seventh coordinate point P7. Then, the relative speed vector V1 at the right end portion of the forward object 200 is calculated by subtracting a coordinate value of the fourth coordinate point P4 from a coordinate value of the sixth coordinate point P6. In a similar manner, the relative speed vector V2 at the left end portion of the forward object 200 is calculated by subtracting a coordinate value of the fifth coordinate point P5 from a coordinate value of the seventh coordinate point P7.

Then, a first extended line EL1 which is an extended line of the relative speed vector V1 starting from the sixth coordinate point P6 indicating a current position of the right end portion of the forward object 200, and a second extended line EL2 which is an extended line of the relative speed vector V2 starting from the left end portion of the forward object 200 are calculated. Then, the lateral direction avoidance amount Xad is calculated as an amount of movement of the own vehicle region RS in an X axis direction, which is required until the first and the second extended lines EL1 and EL2 no longer intersect with the own vehicle region RS.

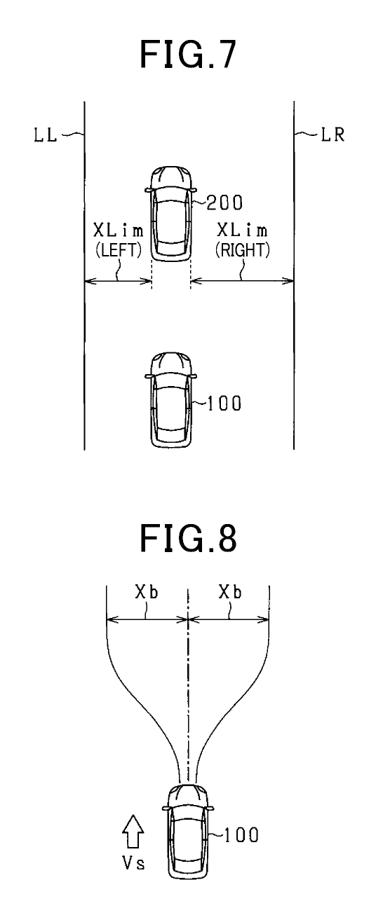

In the first condition, the free space width XLim is a width of evacuation space existing in a horizontal direction of the forward object with respect to the traveling direction of the own vehicle. In the present embodiment, free space widths XLim respectively in the left direction and in the right direction of the forward object are calculated on the basis of the information acquired from the radar sensor 40 and the imaging unit 41. FIG. 7 illustrates left and right free space widths XLim existing between left and right boundaries LL and LR located ahead of the own vehicle 100, and the forward object 200 as a preceding vehicle.

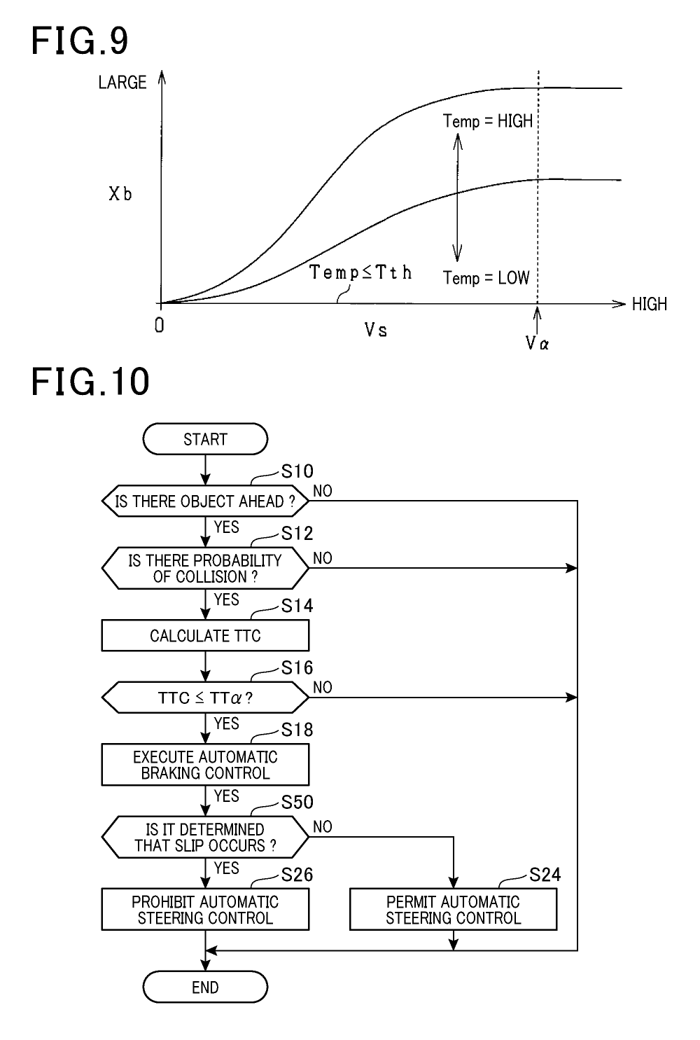

Meanwhile, in the second condition, as illustrated in FIG. 8, the maximum avoidance amount Xb is a maximum value of the lateral direction avoidance amount of the own vehicle 100 which can be reached by the automatic steering control and depends on the own vehicle speed Vs. In the present embodiment, as illustrated in FIG. 9, as the own vehicle speed Vs is higher, the maximum avoidance amount Xb is set larger. Specifically, in the case where the own vehicle speed Vs falls within a speed range between 0 and a predetermined speed Va, the maximum avoidance amount Xb is set larger as the own vehicle speed Vs is higher, and, in the case where the own vehicle speed Vs is equal to or higher than the above-described speed range, the maximum avoidance amount Xb is fixed at a value obtained when the own vehicle speed Vs becomes predetermined speed Va.

Here, in the present embodiment, the maximum avoidance amount Xb is corrected on the basis of the outside air temperature Temp. In the present embodiment, as the outside air temperature Temp is lower, the maximum avoidance amount Xb is made smaller. Particularly, in the present embodiment, in the case where it is determined that the outside air temperature Temp is equal to or lower than the predetermined temperature Tth, the maximum avoidance amount Xb is set at 0.

If the maximum avoidance amount Xb is set at 0, the above-described second condition is not satisfied in step S40. By this means, a negative determination is made in step S40, and execution of the automatic steering control is prohibited in step S26. In this manner, also according to the present embodiment described above, it is possible to provide effects similar to those in the above-described first embodiment.

### Fourth Embodiment

A fourth embodiment will be described below with reference to the drawings mainly concerning differences with the above-described first embodiment. In the present embodiment, a method of determining whether or not the road surface on which the own vehicle is traveling is a low-μ road is changed.

FIG. 10 illustrates a procedure of collision avoidance control processing according to the present embodiment. This processing is repeatedly executed by the control apparatus 10, for example, with a predetermined processing period. Note that, in FIG. 10, the same reference numerals are assigned to processing which is the same as the processing illustrated in previous FIG. 2 for convenience sake.

In this series of processing, after the processing in step S18, in step S50, it is determined whether or not the wheels are slipping. In the present embodiment, whether or not slipping is occurring on the basis of a value of an ABS flag Fabs indicating that ABS control is executed.

In the case where it is determined in step S50 that slipping is not occurring, the processing proceeds to step S24. In contrast, in the case where it is determined in step S50 that slipping is occurring, execution of the automatic steering control is prohibited in step S26.

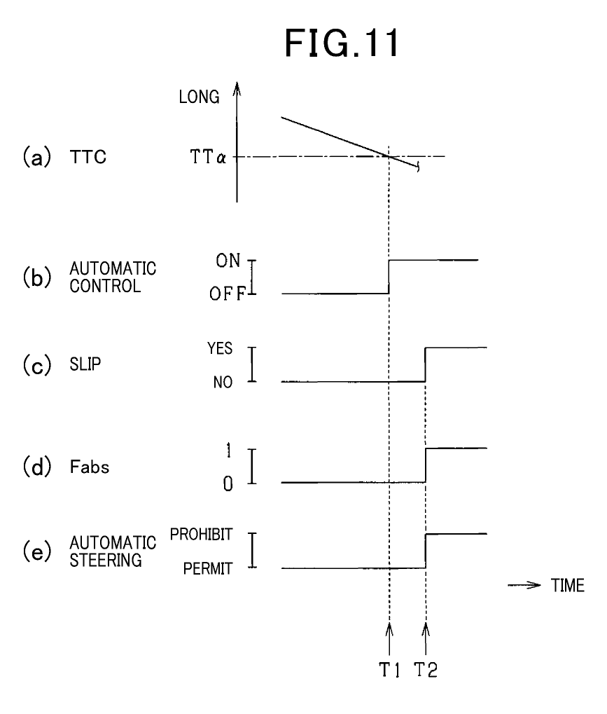

FIG. 11 illustrates an example of collision avoidance control in a situation where an affirmative determination is made in step S12 in previous FIG. 10. Here, FIG. 11(a) illustrates a transition of the collision prediction time TTC, FIG. 11(b) illustrates a transition of a situation in which the automatic braking control is implemented, and FIG. 11(c) illustrates a transition of a situation in which slipping actually occurs. Further, FIG. 11(d) illustrates a transition of the ABS flag Fabs, and FIG. 11(e) illustrates a transition as to whether or not the automatic steering control is prohibited. Note that, when the ABS flag Fabs is 1, it indicates that ABS control is being executed, while, when the ABS flag Fabs is 0, it indicates that ABS control is not being executed.

In the illustrated example, it is determined that the collision prediction time TTC is equal to or less than the threshold time TTa at time T1. Therefore, the automatic braking control is started as the collision avoidance control.

Thereafter, the wheels slip at time T2 due to execution of the automatic braking control. Therefore, the ABS control is started, and the value of the ABS flag Fabs is switched from 0 to 1. By this means, it is determined that slipping is occurring, and execution of the automatic steering control as the collision avoidance control is prohibited.

According to the present embodiment described above, it is possible to accurately detect slipping actually occurring due to the automatic braking control being started and prohibit execution of the automatic steering control. Note that it is also possible to perform setting so that execution of the automatic steering control is programmed in advance so as to be always delayed by “T2−T1” after the start of the automatic braking control. By this setting of delay, it is possible to determine whether or not to perform the automatic steering control while reliably performing determination of whether the road surface is a low-μ road.

### Other Embodiments

Note that the above-described each embodiment may be implemented while modifications are made as follows.

The method of determining whether or not the road surface on which the own vehicle is traveling is a low-μ road is not limited to those illustrated in the above-described embodiments. For example, it is also possible to determine that the road surface is a low-μ road in the case where it is determined that a logical AND of a condition that the outside air temperature Temp is equal to or lower than the predetermined temperature Tth and a condition that snowfall information has been acquired, is true.

In the above-described first embodiment, as the outside air temperature Temp used in step S22 in FIG. 2, temperature information in a region to which the traveling route of the own vehicle belongs acquired by the navigation unit 50 through wireless communication may be used in place of a detection value of the outside air temperature sensor 60.

In the above-described second embodiment, as the snowfall information used in step S32 in FIG. 4, snowfall information manually input by a driver may be used. This snowfall information may only be input by, for example, a snowfall information button displayed on a touch-panel type display unit of the navigation unit 50 being depressed by the driver.

In the processing in step S40 in FIG. 5 in the above-described third embodiment, the maximum avoidance amount Xb may be corrected further using lateral direction acceleration of the own vehicle. This is effective, for example, in the case where the own vehicle travels on a curve.

Further, in step S40, in the case where it is determined that snowfall information has been acquired, the maximum avoidance amount Xb may be set to 0. Further, in step S40, in the case where it is determined that the outside air temperature Temp is equal to or lower than the predetermined temperature Tth, the maximum avoidance amount Xb may be set to a value which is greater than 0 and which is smaller than a minimum value assumed to be as an absolute value of the lateral direction avoidance amount Xad.

In the above-described each embodiment, it is also possible to remove the radar sensor 40 from the vehicle and cause the imaging unit 41 to play a role of the radar sensor 40.

While the present disclosure is described in accordance with examples, it should be understood that the present disclosure is not limited to the examples and structures described above. The present disclosure includes various modified examples and modifications within an equivalent range. In addition, various combinations and forms, and other combinations and forms further including only one element or more or less elements thereof fall within the scope and the spirit of the present disclosure.

1. A vehicle control apparatus comprising:
a collision determining section configured to determine a probability of a collision between an own vehicle and an object located ahead of the own vehicle;
a control section configured to, in a case where it is determined by the collision determining section that there is a probability of a collision, execute automatic steering control of steering the own vehicle as collision avoidance control for avoiding a collision between the own vehicle and the object; and
a road surface determining section configured to perform processing of determining whether or not a road surface on which the own vehicle is traveling is a low-μ road,
wherein the control section prohibits execution of the automatic steering control in a case where it is determined by the road surface determining section that the road surface is a low-μ road.

2. The vehicle control apparatus according to claim 1, comprising:
a temperature acquiring section configured to acquire an outside air temperature around the own vehicle,
wherein the road surface determining section performs processing of determining whether or not the outside air temperature acquired by the temperature acquiring section is equal to or lower than a predetermined temperature as the processing of determination, and
the control section prohibits execution of the automatic steering control in a case where it is determined by the road surface determining section that the outside air temperature is equal to or lower than the predetermined temperature.

3. The vehicle control apparatus according to claim 1, comprising:
an information acquiring section configured to acquire snowfall information in a region to which a traveling route of the own vehicle belongs,
wherein the road surface determining section performs processing of determining whether or not snowfall information has been acquired by the information acquiring section as the processing of determination, and
the control section prohibits execution of the automatic steering control in a case where it is determined by the road surface determining section that the snowfall information has been acquired.

4. The vehicle control apparatus according to claim 1, wherein the control section includes:
an avoidance amount calculating section configured to calculate a lateral direction avoidance amount of the own vehicle required for avoiding a collision with the object in a case where it is determined by the collision determining section that there is a probability of a collision; and
a maximum value calculating section configured to calculate a maximum value of the lateral direction avoidance amount of the own vehicle which can be reached by the automatic steering control, on a basis of a traveling speed of the own vehicle,
the control section executes the automatic steering control under a condition that the lateral avoidance amount is equal to or less than the maximum value, and
the maximum value calculating section sets the maximum value smaller in a case where it is determined by the road surface determining section that the road surface is a low-μ road than in a case where it is determined by the road surface determining section that the road surface is not a low-μ road.

5. The vehicle control apparatus according to claim 1, wherein the control section executes automatic braking control of applying braking force to the own vehicle as the collision avoidance control in a case where it is determined by the collision determining section that there is a probability of a collision,
the road surface determining section performs processing of determining whether or not slipping of the own vehicle is occurring by execution of the automatic braking control as the processing of determination, and
the control section permits execution of the automatic steering control in a case where it is not determined by the road surface determining section that slipping is occurring, and prohibits execution of the automatic steering control in a case where it is determined by the road surface determining section that slipping is occurring, after the automatic braking control is started.
